(19) United States
(12) Patent Application Publication
(10) Pub. No.: US 2025/0377216 A1
(43) Pub. Date: Dec. 11, 2025

(54) PROCESSING DEVICE, PROCESSING METHOD, STORAGE DEVICE STORING PROCESSING PROGRAM

(71) Applicant: J-QuAD DYNAMICS Inc., Tokyo (JP)

(72) Inventors: YUSUKE MATSUMOTO, Tokyo (JP); YASUYUKI MIYAKE, Tokyo (JP); SHIGEHIRO MUTO, Tokyo (JP); HIROAKI SAKAKIBARA, Tokyo (JP)

(21) Appl. No.: 19/077,779

(22) Filed: Mar. 12, 2025

(30) Foreign Application Priority Data
Jun. 11, 2024 (JP) 2024-094695

(51) Int. Cl. G01C 21/00; B60W 60/00

(52) U.S. Cl. CPC G01C 21/3859; B60W 60/001; G01C 21/3848

(57) ABSTRACT

A processing device performing driving environmental data related processing related to a local driving environmental data provided with data in an autonomous driving mode of a host vehicle is provided. The processing device includes a processor and a storage medium. The processor is configured to read the local driving environmental data stored in the storage medium, which includes position information of a node and a link; set a trigger position ahead of the node on the link where the host vehicle is scheduled to travel; and update the local driving environmental data stored in the storage medium with probe information recognized by sensing in the host vehicle, starting from the trigger position.

### CROSS REFERENCE TO RELATED APPLICATION

This application is based on Japanese Patent Application No. 2024-094695 filed on Jun. 11, 2024, the disclosure of which is incorporated herein by reference.

### TECHNICAL FIELD

The present disclosure relates to driving environmental data related technology utilized in vehicle driving.

### BACKGROUND

A related art describes that a driving environmental data is updated using feature points extracted from detection data acquired by an onboard detector.

### SUMMARY

A processing device performing driving environmental data related processing related to a local driving environmental data provided with data in an autonomous driving mode of a host vehicle is provided. The processing device includes a processor and a storage medium. The processor is configured to read the local driving environmental data stored in the storage medium, which includes position information of a node and a link; set a trigger position ahead of the node on the link where the host vehicle is scheduled to travel; and update the local driving environmental data stored in the storage medium with probe information recognized by sensing in the host vehicle, starting from the trigger position.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the physical configuration of a processing device according to an embodiment;

FIG. 2 is a schematic diagram showing the driving environment of a host vehicle to which the embodiment is applied;

FIG. 3 is a schematic diagram for explaining a local driving environmental data according to an embodiment;

FIG. 4 is a schematic diagram for explaining a local driving environmental data according to an embodiment;

FIG. 5 is a block diagram showing the functional configuration of a processing device according to an embodiment;

FIG. 6 is a flowchart showing a processing flow according to an embodiment;

FIG. 7 is a schematic diagram for explaining the processing flow according to an embodiment;

FIG. 8 is a schematic diagram for explaining the processing flow according to an embodiment;

FIG. 9 is a schematic diagram for explaining the processing flow according to an embodiment;

FIG. 10 is a schematic diagram for explaining the processing flow according to an embodiment;

FIG. 11 is a schematic diagram for explaining the processing flow according to an embodiment; and

FIG. 12 is a schematic diagram for explaining the processing flow according to an embodiment.

### DETAILED DESCRIPTION

In a technology disclosed in a related art, the data volume of driving environmental data is reduced by deleting data of points that have fewer matches with feature points extracted from detection data among the feature points included in the driving environmental data. Such data deletion based on matching is realized after the vehicle repeatedly travels the planned area. As a result, when the application to a vehicle in autonomous driving mode is assumed, the driving environmental data before data deletion continues to be provided to the autonomous driving mode. In this case, not only does the data capacity increase until data deletion, but the reliability of the driving environmental data until data deletion may decrease.

The present disclosure provides a processing device that suppresses the data capacity of a highly reliable driving environmental data in data provision to the autonomous driving mode. The present disclosure provides a processing method that reduces the data capacity of a highly reliable driving environmental data in data provision to the autonomous driving mode. The present disclosure provides a processing program that reduces the data capacity of a highly reliable driving environmental data in data provision to the autonomous driving mode.

According to one aspect of the present disclosure, a processing device performing driving environmental data related processing related to a local driving environmental data provided with data in an autonomous driving mode of a host vehicle is provided. The processing device includes a processor; and a storage medium. The processor is configured to read the local driving environmental data stored in the storage medium, which includes position information of a node and a link; set a trigger position ahead of the node on the link where the host vehicle is scheduled to travel; and update the local driving environmental data stored in the storage medium with probe information recognized by sensing in the host vehicle, starting from the trigger position.

According to one aspect of the present disclosure, a processing method executed by a processor for performing driving environmental data related processing related to a local driving environmental data provided with data in an autonomous driving mode of a host vehicle is provided. The method includes reading the local driving environmental data stored in a storage medium, which includes position information of a node and a link, in the host vehicle; setting a trigger position ahead of the node on the link where the host vehicle is scheduled to travel; and updating the local driving environmental data stored in the storage medium with probe information recognized by sensing in the host vehicle, starting from the trigger position.

According to one aspect of the present disclosure, a non-transitory computer readable storage medium storing a processing program stored in a storage medium for performing driving environmental data related processing related to a local driving environmental data provided with data in an autonomous driving mode of a host vehicle is provided. The processing program includes instructions for causing a processor to read the local driving environmental data stored in the storage medium, which includes position information of a node and a link; set a trigger position ahead of the node on the link where the host vehicle is scheduled to travel; and update the local driving environmental data stored in the storage medium with probe information 2recognized by sensing in the host vehicle, starting from the trigger position.

Thus, according to the first to third aspects, from the local driving environmental data stored in the storage medium, which includes position information of nodes and links, a trigger position ahead of the node is set in the link where the host vehicle is scheduled to travel. Therefore, the update based on probe information recognized by sensing in the host vehicle is given to the local driving environmental data stored in the storage medium from the trigger position, thereby concentrating the update particularly on the area ahead of the node where data accuracy is required in the autonomous driving mode. This makes it possible to reduce the data capacity of a highly reliable local driving environmental data in the storage medium for provision to the autonomous driving mode.

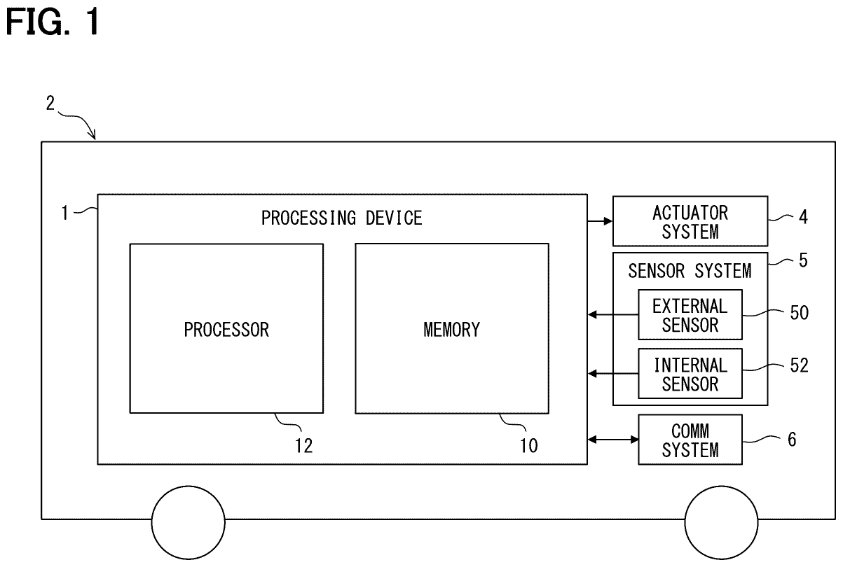

Hereinafter, an embodiment of the present disclosure will be described with reference to the drawings. The processing device 1 according to an embodiment shown in FIG. 1 is mounted on a host vehicle 2 to perform driving environmental data related processing.

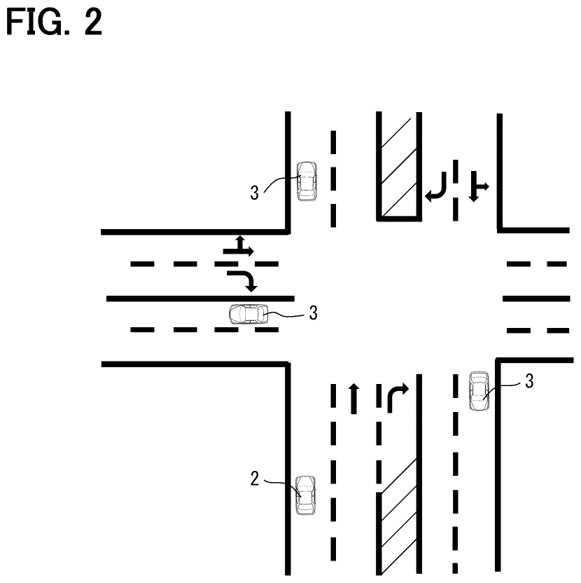

The host vehicle 2 shown in FIG. 1 and FIG. 2 is a road user such as an automobile or a truck. From the perspective centered on itself, the host vehicle 2 may be referred to as an ego-vehicle or a subject vehicle. In the host vehicle 2, an autonomous driving mode corresponding to the degree of manual intervention by the occupant in the controlled driving task is set. The autonomous driving mode may be realized by autonomous driving control in which the system of the host vehicle 2 performs all driving tasks, such as conditional driving automation, high-level driving automation, or full driving automation. The autonomous driving mode may be realized by advanced driving assistance control in which the occupant performs some or all of the driving tasks, such as driving assistance or partial driving automation. The autonomous driving mode may also be realized by switching between such autonomous driving control and advanced driving assistance control.

As shown in FIG. 2, in the driving environment where the host vehicle 2 travels, traffic scenes where a different road user (also referred to as another road user, or other road user) 3 exist besides the host vehicle 2 are assumed. The different road user 3 includes a non-vulnerable road user and a vulnerable road user according to their vulnerability. The non-vulnerable road user is at least one type of vehicle, such as automobile, truck, motorcycle, bicycle, and micromobility. The vulnerable user is human, such as a pedestrian.

As shown in FIG. 1, the host vehicle 2 is equipped with an actuator system 4, a sensor system 5, and a communication system 6, along with the processing device 1. The processing device 1 may be implemented in the form of a control device (e.g., control circuit) or a semiconductor device (e.g., semiconductor chip).

The actuator system 4 is configured to drive the host vehicle 2 based on control commands given by the processing device 1. The actuator system 4 may be at least one type of a powertrain actuator, such as an internal combustion engine or a motor generator. The actuator system 4 may be at least one type of a braking actuator, such as a brake unit. The actuator system 4 may be at least one type of a steering actuator, such as a power steering unit. In addition, the actuator system 4 may include at least one type of an actuator that performs functions such as lighting, direction indication, hazard indication, warning sound, and windshield wiping in the host vehicle 2.

The sensor system 5 senses the external and internal environments of the host vehicle 2 to acquire sensing information. The sensor system 5 includes an external sensor 50 and an internal sensor 52.

The external sensor 50 sense an object present in the external environment of the host vehicle 2. The external sensor 50 of the object-sensing type may be at least one type of a sensor, such as an onboard camera, LiDAR (light detection and ranging/laser imaging detection and ranging), radar, or sonar. The external sensors 50 of the object-sensing type may be mounted in combination to sense the front, sides, and rear of the host vehicle 2.

The internal sensor 52 senses physical quantity of a specific movement in the internal environment of the host vehicle 2. The internal sensor 52 of the motion-sensing type may be at least one type of a sensor, such as a speed sensor, an acceleration sensor, a gyro sensor, or an inertial sensor. The internal sensor 52 may sense the operation or state of the occupant, including the driver, in the internal environment of the host vehicle 2. The internal sensor 52 of the occupant-sensing type may be at least one type of a sensor, such as an accelerator pedal sensor, a brake pedal sensor, a shift sensor, a steering sensor, an occupant camera, or an occupant seat switch.

The communication system 6 acquires communication information through wireless communication. The communication system 6 may receive positioning signals from GNSS (global navigation satellite system) satellites present in the external environment of the host vehicle 2. The communication system 6 of the positioning type may be a GNSS receiver. The communication system 6 may send and receive communication signals to and from a V2X system present in the external environment of the host vehicle 2. The communication system 6 of the V2X communication type may be at least one type of device, such as a DSRC (dedicated short range communications) communication device or a cellular V2X (C-V2X) communication device. The communication system 6 may send and receive communication signals to and from a mobile terminal present in the internal environment of the host vehicle 2. The communication system 6 of the terminal communication type may be at least one type of device, such as a Bluetooth (registered trademark) device, Wi-Fi (registered trademark) device, or infrared communication device.

The processing device 1 is connected to the actuator system 4, the sensor system 5, and the communication system 6 via at least one type of connection, such as a LAN (local area network), a wire harness, an internal bus, or a wireless communication line. The processing device 1 includes at least one dedicated computer.

The dedicated computer constituting the processing device 1 may be a sensing ECU (electronic control unit) that processes sensing information in the driving control of the host vehicle 2. The dedicated computer constituting the processing device 1 may be a recognition ECU that recognizes the external environment in the driving control of the host vehicle 2. The dedicated computer constituting the processing device 1 may be a locator ECU that estimates the self-position of the host vehicle 2. The dedicated computer constituting the processing device 1 may be a navigation ECU that navigates the driving route in the driving control of the host vehicle 2. The dedicated computer constituting the processing device 1 may be an integrated ECU that integrates the driving control of the host vehicle 2. The dedicated computer constituting the processing device 1 may be a planning ECU that plans the driving control of the host vehicle 2. The dedicated computer constituting the processing device 1 may be an actuator ECU that controls the actuator system 4 as the driving control of the host vehicle 2.

The dedicated computer constituting the processing device 1 includes at least one memory 10 and at least one processor 12. The memory 10 of the processing device 1 is a non-transitory tangible storage medium that non-temporarily stores programs and data readable by a computer, such as at least one type of semiconductor memory, magnetic medium, or optical medium. The processor 12 includes at least one type of core, such as a CPU (central processing unit), GPU (graphics processing unit), or RISC (reduced instruction set computer) CPU.

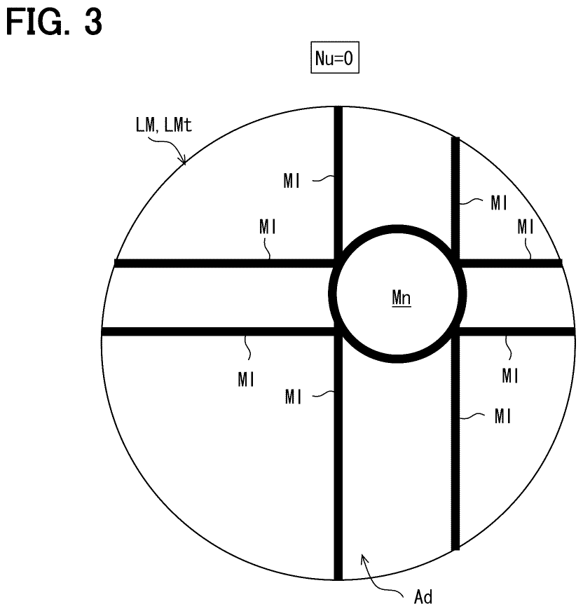

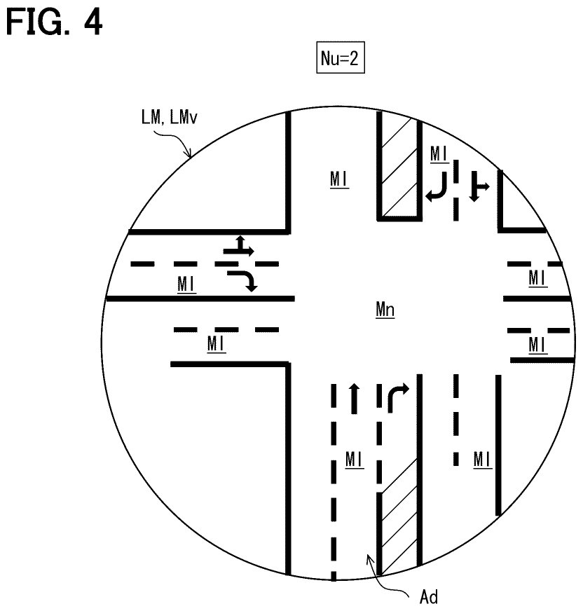

At least one memory 10 in the processing device 1 stores a local driving environmental data LM (see FIG. 3 and FIG. 4 described later) that is uniquely updated for the host vehicle 2 as driving environmental data information. The memory 10 storing the local driving environmental data LM may function as a database for a locator that estimates the self-position of the host vehicle 2. The memory 10 storing the local driving environmental data LM may function as a database for a navigation unit that navigates the driving route of the host vehicle 2. The memory 10 storing the local driving environmental data LM may be configured by a combination of multiple types of these databases.

As the local driving environmental data LM, for example, at the factory shipment stage of the host vehicle 2, a topological driving environmental data LMt as shown in FIG. 3 is initially stored in the memory 10. The topological driving environmental data LMt is a digital driving environmental data of two-dimensional or three-dimensional data that defines the driving environment of the host vehicle 2 by abstracting it into a graph structure with nodes (i.e., vertices) Mn, which are at least one type of intersection, merge point, or branch point, and links (i.e., edges) MI, which connect the nodes Mn, such as driving paths. The topological driving environmental data LMt includes at least the position information of each node Mn and the relative position information between the nodes Mn at both ends of each link MI. Such a topological driving environmental data LMt is described in at least one type of format, such as a text format or a graphical format.

On the other hand, in the driving area where the host vehicle 2 has traveled after the initial run, the local driving environmental data LM is updated in the memory 10 to a vector driving environmental data LMv as shown in FIG. 4. The vector driving environmental data LMv is a digital driving environmental data of three-dimensional data that defines the driving environment of the host vehicle 2, including nodes Mn and multiple links MI, based on point cloud information Ipp (see FIG. 11 described later). The vector driving environmental data LMv includes the position information of point clouds that define at least one type of road structure, such as intersections, merge points, and branch points, which constitute the nodes Mn, and the position information of point clouds that define road structures, such as driving paths, which constitute the links MI.

Such a vector driving environmental data LMv is described in a graphical format. Therefore, the vector driving environmental data LMv may be stored in the memory 10 as a three-dimensional dynamic driving environmental data that includes, for example, structure information and/or sign information. Furthermore, the vector driving environmental data LMv of this embodiment is stored in the memory 10 in association with the update count Nu in the planned driving area Ad to be updated (see FIG. 6 to FIG. 8 described later).

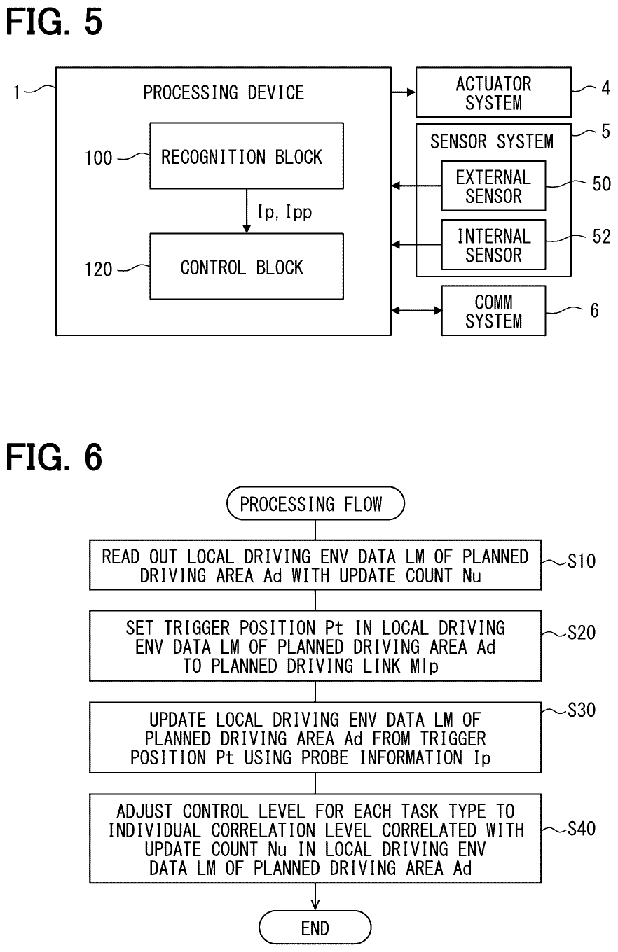

The processor 12 of the processing device 1 shown in FIG. 1 executes multiple instructions included in the processing program stored in the memory 10 as software. As a result, the processing device 1 constructs multiple functional blocks to perform a driving environmental data related processing related to the local driving environmental data LM provided to the autonomous driving mode of the host vehicle 2. The multiple functional blocks constructed by the processing device 1 include a recognition block 100 and a control block 120, as shown in FIG. 5.

The recognition block 100 acquires sensing information from the sensor system 5. The recognition block 100 acquires communication information from the communication system 6. The recognition block 100 acquires the local driving environmental data LM stored in the memory 10 as driving environmental data information by reading it from the memory 10. The recognition block 100 acquires past information of control commands to the host vehicle 2 from the control block 120 by reading it from the memory 10. The recognition block 100 processes these acquired pieces of information individually and then fuses them to generate probe information Ip, which recognizes the driving environment of the host vehicle 2 for each driving scene.

Specifically, the recognition block 100 generates probe information Ip by recognizing the driving path, including nodes Mn and links MI (see FIG. 3 and FIG. 4), as the driving environment of the host vehicle 2. The probe information Ip related to the driving path represents at least one type of road condition, such as the position of intersections, merge points, and branch points, the position and size of the driving path, the bending points of the driving path, the curvature or radius of the driving path, and the position and size of pedestrian paths. Furthermore, the probe information Ip of this embodiment is generated to include point cloud information Ipp (see FIG. 11) that recognizes static objects in the driving environment of the host vehicle 2 as point clouds from the sensing information recognized by the external sensor 50. At this time, the point cloud information Ipp is constructed by SfM (structure from motion) processing on multiple frames of captured images by an onboard camera as the external sensor 50 and/or scanning processing by LiDAR as the external sensor 50.

The recognition block 100 also generates probe information Ip by recognizing the different road user 3 present in the external environment of the host vehicle 2. The probe information Ip related to the different road user 3 represents at least one type of motion physical quantity, such as position, separation distance, movement direction, relative speed, relative acceleration, and collision margin time. The probe information Ip related to the different road user 3 may represent the classification of the different road user 3 clustered based on such motion physical quantities. Furthermore, the probe information Ip of this embodiment is generated to include point cloud information Ipp (see FIG. 11) that recognizes a dynamic object, which is the different road user 3, as point clouds from the sensing information recognized by the external sensor 50 in the host vehicle 2. At this time, the point cloud information Ipp is also constructed by SfM processing on multiple frames of captured images by an onboard camera as the external sensor 50 and/or scanning processing by LiDAR as the external sensor 50.

The recognition block 100 also generates probe information Ip by localization that recognizes the self-state, including the self-position of the host vehicle 2. The probe information Ip related to the self-state represents at least one type of self-state, such as self-position, attitude angle, steering angle, speed, acceleration, jerk, and yaw rate, which appear in the host vehicle 2 according to the control commands of the control block 120.

As shown in FIG. 5, the control block 120 acquires probe information Ip from the recognition block 100. The control block 120 acquires the local driving environmental data LM stored in the memory 10 as driving environmental data information by reading it from the memory 10. The control block 120 acquires past information of its control commands to the host vehicle 2 by reading it from the memory 10. Based on this acquired information, the control block 120 plans the target driving trajectory in the autonomous driving mode of the host vehicle 2. At this time, the driving trajectory defines the time-series changes in the control cycle expected in the future from the present concerning the target motion parameters as the self-state of the host vehicle 2.

The control block 120 generates control commands to drive the host vehicle 2 in the autonomous driving mode based on the trajectory information related to the planned driving trajectory, along with the probe information Ip and past information of control commands from the recognition block 100. At this time, control commands, which are given to the actuator system 4, are generated to individually control multiple types of driving tasks adjusted according to the autonomous driving level corresponding to the driving scene among the autonomous driving tasks and manual driving assistance tasks in the host vehicle 2. The information of the generated control commands is stored in the memory 10.

### Processing Flow

The processing method for performing driving environmental data related processing of the host vehicle 2 by the blocks 100 and 120 described above is executed according to the processing flow shown in FIG. 6. This processing flow is repeatedly executed while the host vehicle 2 is in operation. In the following description, each “S” in the processing flow represents multiple steps executed by multiple instructions included in the processing program.

In S10, the recognition block 100 reads the local driving environmental data LM stored in the memory 10, which includes the position information of nodes Mn and links MI for the planned driving area Ad where the host vehicle 2 is scheduled to travel, along with the update count Nu. Specifically, in S10, the recognition block 100 recognizes the planned driving area Ad to be updated in the current flow based on the driving trajectory planned by the control block 120 in a past flow and/or a current flow. Therefore, in S10, the recognition block 100 reads the local driving environmental data LM corresponding to the recognized planned driving area Ad from the memory 10 along with the associated update count Nu.

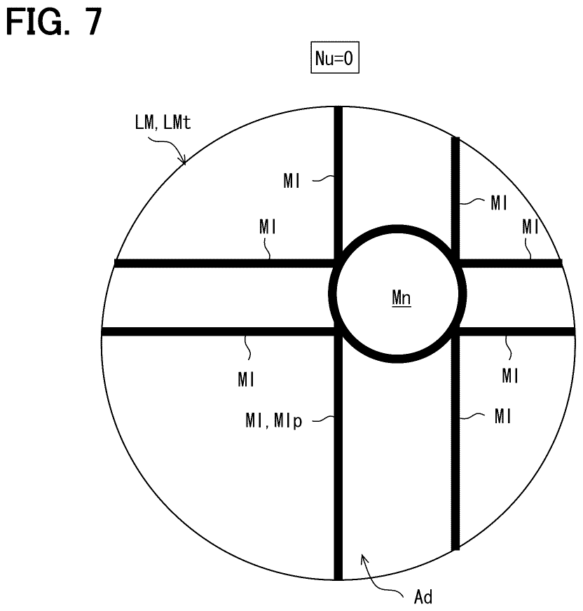

As a result, for example, when the host vehicle 2 travels the planned driving area Ad for the first time after factory shipment, the update count Nu in the area Ad is zero, as shown in FIG. 3. Therefore, the recognition block 100 reads the initially stored topological driving environmental data LMt as the local driving environmental data LM from the memory 10. In this case, as shown in FIG. 7, the recognition block 100 identifies the planned driving link MIp, which is the recognized link MI in the planned driving area Ad, in the read topological driving environmental data LMt.

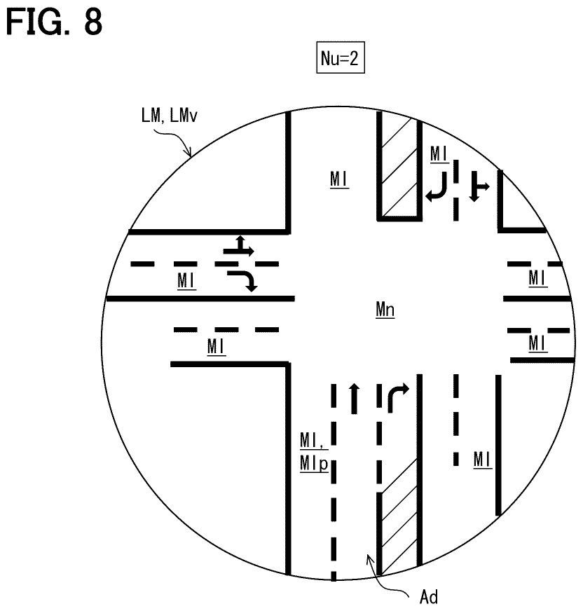

On the other hand, when the host vehicle 2 re-travels (i.e., travels for the second time or more) the planned driving area Ad, the update count Nu in the area Ad is one or more, as shown in the drawing. Therefore, the recognition block 100 reads the vector driving environmental data LMv, which has been updated after the initial travel of the host vehicle 2 in the planned driving area Ad, as the local driving environmental data LM from the memory 10. In this case, as shown in FIG. 8, the recognition block 100 identifies the planned driving link MIp, which is the recognized link MI in the planned driving area Ad, in the read vector driving environmental data LMv.

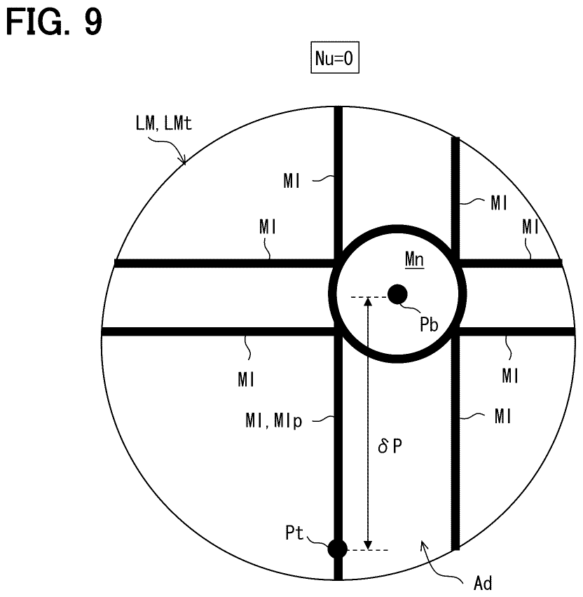

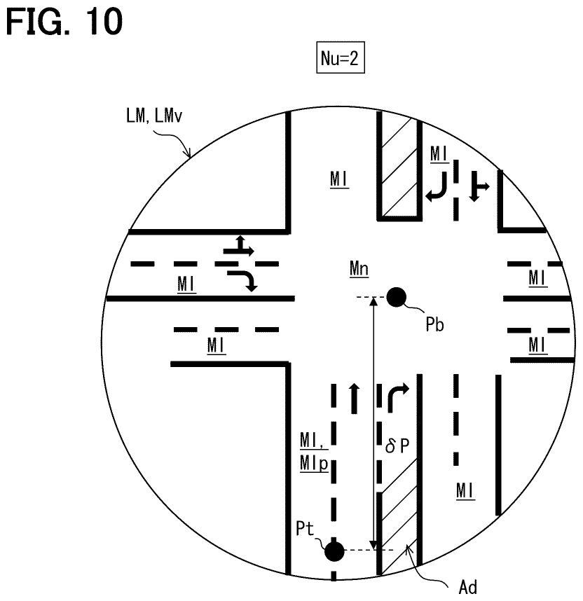

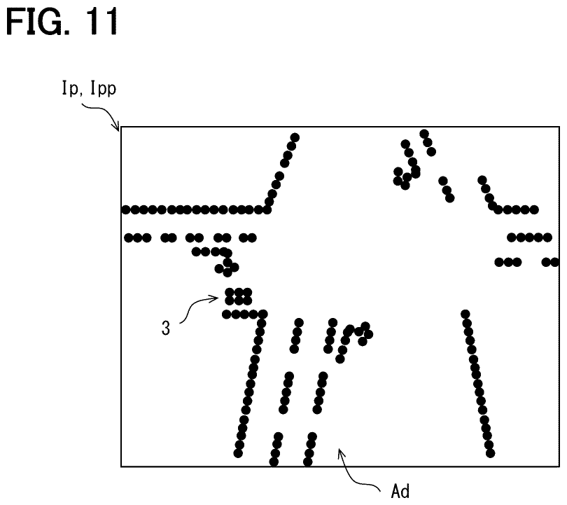

As shown in FIG. 6, in S20 following S10 in the processing flow, the recognition block 100 sets a trigger position Pt in the planned driving link MIp identified in the local driving environmental data LM of the planned driving area Ad. Specifically, in S20, the recognition block 100 sets the trigger position Pt ahead of the reference position Pb, which is the position of the node Mn further identified at the driving side end of the planned driving link MIp in the local driving environmental data LM of the planned driving area Ad. As an example, in S20, the recognition block 100 sets the trigger position Pt at a location closer to the host vehicle 2 than the reference position Pb. In other words, the trigger position Pt is located before the node Mn in the scheduled travel link MIp. Therefore, in S20, as shown in FIG. 9 and FIG. 10, the recognition block 100 adjusts the section distance δP, which is the distance back from the node Mn of the reference position Pb in the planned driving link MIp, according to the expected driving scene of the host vehicle 2 in the link MI.

At this time, the collision risk between the host vehicle 2 and the different road user 3 is predicted to increase as the host vehicle 2 approaches the node Mn of the reference position Pb, and the rate of increase in the risk per unit driving distance varies according to the driving scene. Therefore, the section distance δP is adjusted to be longer as the rate of increase in the risk per unit driving distance increases according to the driving scene. For example, in driving scenes such as highways or expressways with higher legal speed limits than general roads, the section distance δP set before merge points or branch points like interchanges is adjusted to be longer than the section distance δP set before intersections in general road driving scenes.

Such variable adjustment of the section distance δP is applied in both the case of the topological driving environmental data LMt as shown in FIG. 9 and the case of the vector driving environmental data LMv as shown in FIG. 10. As a result, the trigger position Pt is set to leave the adjusted section distance δP back from the node Mn of the reference position Pb in the topological driving environmental data LMt or the vector driving environmental data LMv according to the update count Nu in the planned driving area Ad.

As shown in FIG. 6, in S30 following S20 in the processing flow, the recognition block 100 updates the local driving environmental data LM of the planned driving area Ad stored in the memory 10 from the trigger position Pt set in S20. Specifically, in S30, the recognition block 100 starts updating the local driving environmental data LM based on the probe information Ip recognized by sensing in the host vehicle 2 from the trigger position Pt of the planned driving link MIp. Therefore, the update of the local driving environmental data LM may be executed at least at the trigger position Pt, but it may also be executed at each driving point according to the control cycle within the section distance δP from the trigger position Pt to the node Mn of the reference position Pb in the planned driving link MIp.

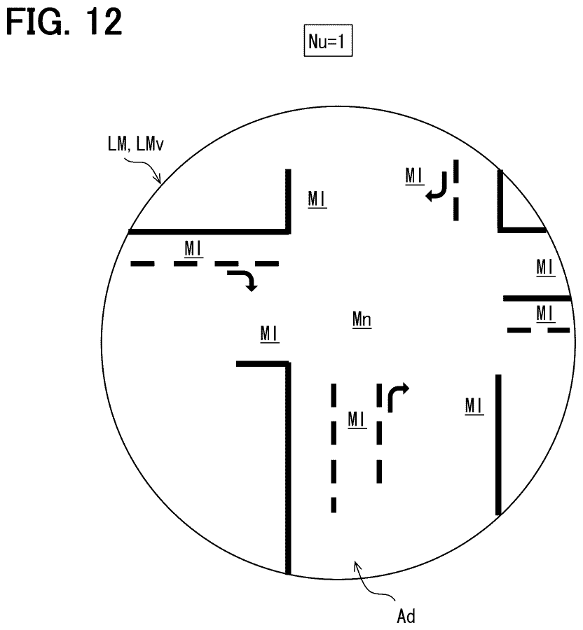

At this time, in S30 after the topological driving environmental data LMt initially stored is read in S10, the vector driving environmental data LMv is newly generated for the planned driving area Ad from the probe information Ip including the point cloud information Ipp as shown in FIG. 12. Therefore, in S30, the recognition block 100 performs a replacement update to replace the topological driving environmental data LMt in the memory 10 with the newly generated vector driving environmental data LMv of the planned driving area Ad. At this time, the update count Nu is incremented by one and overwritten in the memory 10 in association with the updated vector driving environmental data LMv.

On the other hand, in S30 after the vector driving environmental data LMv updated after the initial travel is read in S10, a merge update is performed by the recognition block 100 to merge the probe information Ip including the point cloud information Ipp into the vector driving environmental data LMv, as shown in FIG. 12. At this time, the old vector driving environmental data LMv in the memory 10 may be replaced by the updated driving environmental data in which the probe information Ip is merged into the read vector driving environmental data LMv, or the probe information Ip may be directly merged into the old vector driving environmental data LMv in the memory 10. In either case, the update count Nu is incremented by one and overwritten in the memory 10 in association with the updated vector driving environmental data LMv. Furthermore, in the merge update, topological information abstracted into a graph structure similar to the topological driving environmental data LMt by subdividing the links MI and nodes Mn by driving lanes may be merged into the vector driving environmental data LMv as probe information Ip.

As shown in FIG. 6, in S40 following S30 in the processing flow, the control block 120 reads the latest local driving environmental data LM updated from the trigger position Pt by the probe information Ip in S30 from the memory 10. Thus, the latest local driving environmental data LM is provided as data for the planning of the driving trajectory and the generation of control commands by the control block 120 for the driving control of the host vehicle 2 in the autonomous driving mode.

Therefore, in S40, the control block 120 adjusts the control levels for multiple types of driving tasks to be controlled according to the driving scene of the host vehicle 2 in the autonomous driving mode. The types of driving tasks (also referred to as task types) include at least the basic driving functions of the host vehicle 2, such as acceleration tasks, braking tasks, and steering tasks. In addition to these basic driving functions, the task types may include at least one type of function, such as lighting tasks, direction indication tasks, hazard indication tasks, warning sound tasks, and windshield wiping tasks.

In S40, the control levels of these driving tasks are adjusted to individual correlation levels correlated with the update count Nu associated with the local driving environmental data LM of the planned driving area Ad updated in S30, for each task type. At this time, the control levels of each driving task are gradually advanced correlation levels that follow the increase in the update count Nu, and the pattern of this following is adjusted to different correlation levels for each task type. Therefore, the control levels of each driving task are adjusted to a higher level in response to the update count Nu exceeding or being equal to the threshold number set differently for each task type.

In this embodiment, in particular, the driving tasks are classified into at least two or more groups, from a group with low required accuracy of the local driving environmental data LM in the autonomous driving mode to a group with strict required accuracy, according to the driving scene within the section distance OP predicted in S20. For example, the driving tasks in the driving scene where the planned driving link MIp to the intersection, which is the node Mn of the reference position Pb, is a straight driving path, may be classified into a group including steering tasks and a group including acceleration and braking tasks, in order of lower required accuracy. Alternatively, the driving tasks in such a straight driving scene may be classified into a group including steering tasks, a group including acceleration tasks, and a group including braking tasks, in order of lower required accuracy.

In S40, it is preferable that the threshold number is set to be smaller for the driving tasks classified into the group with lower required accuracy of the local driving environmental data LM for each driving point according to the control cycle within the section distance δP. At this time, even for the same driving task, the threshold number may be set to increase for each driving point as the driving point within the section distance δP approaches the node Mn of the reference position Pb. Also, while updating the local driving environmental data LM for each driving point according to the control cycle within the section distance δP, if S30 is continuously executed, S40 may be repeatedly executed each time the update is provided. In this case, the control level of the driving task may be adjusted to the individual correlation level for each task type according to the threshold number set for the corresponding driving point with each update of the local driving environmental data LM.

In addition to the above, in S40, the control block 120 may further correct the correlation level correlated with the update count Nu and the threshold number based on the influence degree caused by the sensing of the different road user 3 in the probe information Ip provided in the update of the local driving environmental data LM in S30. At this time, the influence degree is defined by the sensing ratio of the number of point clouds of static objects necessary for updating the local driving environmental data LM to the number of point clouds of the different road user 3 that reduce the update accuracy of the local driving environmental data LM in the point cloud information Ipp (see FIG. 11) derived from sensing in the probe information Ip. Therefore, as the sensing ratio of the different road user 3 to such static objects increases, the control level of each driving task may be corrected to decrease from the correlation level based on the update count Nu and the threshold number. Note that S40 described above is completed as the host vehicle 2 reaches the node Mn of the reference position Pb in the planned driving area Ad, and the current flow ends with this completion.

Example of the effects of the embodiment described above will be explained below.

According to this embodiment, from the local driving environmental data LM stored in the memory 10, which includes the position information of nodes Mn and links MI, a trigger position Pt is set ahead of the node Mn in the link MI where the host vehicle 2 is scheduled to travel (in this embodiment, the planned driving link MIp). Therefore, the update based on the probe information Ip recognized by sensing in the host vehicle 2 is given to the local driving environmental data LM stored in the memory 10 from the trigger position Pt, thereby concentrating the update particularly on the area ahead of the node Mn where data accuracy is required in the autonomous driving mode. This makes it possible to reduce the data capacity of a highly reliable local driving environmental data LM in the memory 10 for provision to the autonomous driving mode.

According to this embodiment, the trigger position Pt is set by adjusting the section distance δP from the node Mn according to the driving scene of the host vehicle 2 in the link MI. This allows the section distance δP, where data accuracy is particularly required ahead of the node Mn in the autonomous driving mode, to be adapted to the driving scene. Therefore, it is possible to ensure high reliability of the local driving environmental data LM with reduced data capacity to the necessary amount for the driving scene.

According to this embodiment, in the link MI where the host vehicle 2 travels for the first time, the topological driving environmental data LMt initially stored in the memory 10 as the local driving environmental data LM is read. Therefore, in the link MI where the host vehicle 2 travels for the first time, the topological driving environmental data LMt initially stored is replaced and updated by the vector driving environmental data LMv generated from the probe information Ip recognized by sensing in the host vehicle 2. This allows the update from the minimum necessary low data capacity topological driving environmental data LMt to the highly reliable vector driving environmental data LMv utilizing the probe information Ip to be concentrated ahead of the node Mn during the autonomous driving mode, thereby suppressing the increase in data capacity.

According to this embodiment, in the link MI where the host vehicle 2 travels for the first time, the topological driving environmental data LMt initially stored is replaced and updated by the vector driving environmental data LMv generated from the probe information Ip including the point cloud information Ipp that recognizes the driving environment of the host vehicle 2 as point clouds. This allows the update from the minimum necessary low data capacity topological driving environmental data LMt to the vector driving environmental data LMv utilizing the high-precision point cloud information Ipp to be concentrated ahead of the node Mn during the autonomous driving mode, thereby ensuring the reliability of the driving environmental data update while suppressing the increase in data capacity.

According to this embodiment, in the link MI where the host vehicle 2 re-travels, the vector driving environmental data LMv updated after the initial travel of the host vehicle 2 is read. Therefore, in the link MI where the host vehicle 2 re-travels, the vector driving environmental data LMv updated after the initial travel is further updated by merging the probe information Ip recognized by sensing in the host vehicle 2. This allows the vector driving environmental data LMv utilizing the probe information Ip to be concentrated and sequentially updated ahead of the node Mn each time the host vehicle 2 travels the same link MI during the autonomous driving mode, thereby enhancing the reliability of the driving environmental data update while suppressing the increase in data capacity.

According to this embodiment, the latest local driving environmental data LM updated from the trigger position Pt by the probe information Ip in the memory 10 is provided as data for the driving control of the host vehicle 2 in the autonomous driving mode from the area ahead of the node Mn. Therefore, it is possible to provide a local driving environmental data LM that contributes to the autonomous driving mode with both high reliability and low data capacity.

### Other Embodiments

While one embodiment has been described above, the present disclosure is not limited to the described embodiment and can be applied to various embodiments within the scope of the present disclosure.

In a modification, the dedicated computer constituting the processing device 1 may have at least one of a digital circuit and an analog circuit as the processor. Here, the digital circuit may be at least one type of circuit, such as an ASIC (Application Specific Integrated Circuit), FPGA (Field Programmable Gate Array), SoC (System on a Chip), PGA (Programmable Gate Array), or CPLD (Complex Programmable Logic Device). Such digital circuits may also have a memory that stores programs.

In a modification, when the host vehicle 2 travels the planned driving area Ad for the first time, the vector driving environmental data LMv initially stored in the memory 10 may be read in S10 and updated in S30 by merging the probe information Ip. In this case, the initially stored vector driving environmental data LMv may be constructed to include only the position information of the nodes Mn and links MI necessary for the autonomous driving mode.

In a modification of S20, the section distance OP for determining the trigger position Pt may be fixed to a substantially constant distance regardless of the driving scene. In a modification of S40, the correction based on the influence degree caused by the sensing of the different road user 3 in the probe information Ip may be omitted for the correlation level correlated with the update count Nu. In a modification, the processing device 1 may be configured to realize only the autonomous driving tasks without the existence of manual driving assistance tasks.

It is noted that a flowchart or the processing of the flowchart in the present application includes multiple steps (also referred to as sections), each of which is represented, for instance, as S10. Further, each step can be divided into several sub-steps while several steps can be combined into a single step. While various embodiments, configurations, and aspects of travel assistance method and travel assistance apparatus according to the present disclosure have been exemplified, the embodiments, configurations, and aspects of the present disclosure are not limited to those described above. For example, embodiments, configurations, and aspects obtained from an appropriate combination of technical elements disclosed in different embodiments, configurations, and aspects are also included within the scope of the embodiments, configurations, and aspects of the present disclosure. The local driving environmental data LM may be referred to as a local driving environmental data LM. The topological driving environmental data LMt may be referred to a topological driving environmental data LMt. The digital driving environmental data may be referred to a digital driving environmental data. The vector driving environmental data LMv may be referred to a vector driving environmental data LMv. The three-dimensional dynamic driving environmental data may be referred to a three-dimensional dynamic driving environmental data.

What is claimed is:

1. A processing device performing driving environmental data related processing related to a local driving environmental data provided with data in an autonomous driving mode of a host vehicle, the processing device comprising:
a processor; and
a storage medium,
wherein
the processor is configured to:
read the local driving environmental data stored in the storage medium, which includes position information of a node and a link;
set a trigger position ahead of the node on the link where the host vehicle is scheduled to travel; and
update the local driving environmental data stored in the storage medium with probe information recognized by sensing in the host vehicle, starting from the trigger position.

2. The processing device according to claim 1, wherein
setting the trigger position includes setting the trigger position of which a section distance from the node is adjusted for each driving scene of the host vehicle on the link.

3. The processing device according to claim 1, wherein
setting the trigger position includes reading a topological driving environmental data, which is initially stored in the storage medium, as the local driving environmental data on the link where the host vehicle is traveling for a first time, and
updating the local driving environmental data includes replacing and updating the topological driving environmental data, which is initially stored, with a vector driving environmental data generated from the probe information on the link where the host vehicle is traveling for the first time.

4. The processing device according to claim 3, wherein
updating the local driving environmental data includes replacing and updating the topological driving environmental data, which is initially stored, with the vector driving environmental data generated from the probe information, which includes point cloud information recognized as a point cloud of a driving environment of the host vehicle on the link where the host vehicle is traveling for the first time.

5. The processing device according to claim 3, wherein
setting the trigger position includes reading the vector driving environmental data updated after an initial travel of the host vehicle on the link where the host vehicle is re-traveling, and
updating the local driving environmental data includes updating the vector driving environmental data in the storage medium, which has been updated after the initial travel, by merging the probe information on the link where the host vehicle is re-traveling.

6. The processing device according to claim 1, wherein
the processor is further configured to provide data to driving control of the host vehicle in the autonomous driving mode with the local driving environmental data latest and updated from the trigger position by the probe information in the storage medium.

7. A processing method executed by a processor for performing driving environmental data related processing related to a local driving environmental data provided with data in an autonomous driving mode of a host vehicle, the method comprising:
reading the local driving environmental data stored in a storage medium, which includes position information of a node and a link, in the host vehicle;
setting a trigger position ahead of the node on the link where the host vehicle is scheduled to travel; and
updating the local driving environmental data stored in the storage medium with probe information recognized by sensing in the host vehicle, starting from the trigger position.

8. A non-transitory computer readable storage medium storing a processing program stored in a storage medium for performing driving environmental data related processing related to a local driving environmental data provided with data in an autonomous driving mode of a host vehicle, the processing program including instructions for causing a processor to:
read the local driving environmental data stored in the storage medium, which includes position information of a node and a link;
set a trigger position ahead of the node on the link where the host vehicle is scheduled to travel; and
update the local driving environmental data stored in the storage medium with probe information recognized by sensing in the host vehicle, starting from the trigger position.
